(19) United States
(12) Patent Application Publication
(10) Pub. No.: US 2007/0061309 A1
(43) Pub. Date: Mar. 15, 2007

(54) System and method for color-based searching of media content

(75) Inventor: Eric N. Klein JR., Cupertino, CA (US)

Correspondence Address: HOLLAND & KNIGHT LLP, 10 ST. JAMES AVENUE, BOSTON, MA, 02116, US

(73) Assignee: RealNetworks, Inc., Seattle, WA (US)

(21) Appl. No.: 11/501,203

(22) Filed: Aug. 7, 2006

Related U.S. Application Data
(60) Provisional application No. 60/705,764, filed on Aug. 5, 2005.
(60) Provisional application No. 60/705,969, filed on Aug. 5, 2005.
(60) Provisional application No. 60/705,747, filed on Aug. 5, 2005.

(51) Int. Cl. G06F 17/30

(52) U.S. Cl. 707/3

(57) ABSTRACT

A method, computer program product and computing device for receiving a selected color representation selected by a user. At least one characteristic associated with the selected color representation is retrieved. One or more media data files, chosen from a plurality of media data files, associated with the at least one characteristic is identified. The one or more media data files associated with the at least one characteristic is presented to the user.

### RELATED APPLICATIONS

This application claims the priority of the following applications, which are herein incorporated by reference: U.S. Provisional Application Ser. No. 60/705,764, entitled, “SYSTEMS AND METHODS FOR PRESENTING MEDIA CONTENT”, filed 5 Aug. 2005; U.S. Provisional Application Ser. No. 60/705,969, entitled, “SYSTEMS AND METHODS FOR USING PERSONAL MEDIA DEVICE”, filed 5 Aug. 2005; and U.S. Provisional Application Ser. No. 60/705,747, entitled, “PERSONAL MEDIA DEVICE AND METHODS OF USING SAME”, filed 5 Aug. 2005.

### TECHNICAL FIELD

The disclosure relates to color-based associations and, more particularly, to associating color with media data files.

### BACKGROUND

Media distribution systems (e.g., the Rhapsody™ service offered by RealNetworks, Inc of Seattle, Wash.) may distribute media content (e.g., audio files, video files, and audio/video files) from a media server to a client electronic device (e.g., an MP3 player). A media distribution system may distribute media content by allowing a user to download media data files and/or receive and process media data streams.

When searching for media content to download/render, the user may not be interested in searching for media based on artist or artist type (e.g., oldies, R&B, classic rock, etc.). For example, the user may be interested in searching for particular music tracks that set a mood (e.g., happy, sad, romantic, etc). However, searching for music based on “mood” may prove to be a difficult task.

### SUMMARY OF DISCLOSURE

In a first implementation, a method receives a selected color representation selected by a user. At least one characteristic associated with the selected color representation is retrieved. One or more media data files, chosen from a plurality of media data files, associated with the at least one characteristic is identified. The one or more media data files associated with the at least one characteristic is presented to the user.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a DRM process, a media distribution system, a client application, a proxy application, and a personal media device coupled to a distributed computing network;

FIG. 2 is an isometric view of the personal media device of FIG. 1;

FIG. 3 is a diagrammatic view of the personal media device of FIG. 1;

FIG. 4 is a diagrammatic view of a system for searching text associated with media content;

FIG. 5 is a flow chart illustrating a method for searching text associated with media content;

FIG. 6 is a diagrammatic view of a system for providing a color based interface for selecting media content;

FIG. 7 is a flow chart illustrating a method of providing a color-based user interface for selecting media content;

FIG. 8 is a flow chart illustrating a method for individually associating content characteristic data with media content;

FIG. 9 is a flow chart illustrating a method for automatically associating content characteristic data with media content;

FIG. 10 is a diagrammatic view of a system for presenting media content chronologically with historical events;

FIG. 11 is a flow chart illustrating a method for presenting media content chronologically with historical events;

FIG. 12 is a diagrammatic view of a system for establishing non-interactive media content based on user metadata;

FIG. 13 is a flow chart illustrating a method of establishing non-interactive media content based on user metadata;

FIG. 14 is a flow chart illustrating a method of rendering non-interactive media content to provide a non-interactive media content playback;

FIG. 15 is a diagrammatic view of a system for local generation of non-interactive media content;

FIG. 16 is a flow chart illustrating a method for local generation of non-interactive media content;

FIG. 17 is a diagrammatic view of a system for combining disparate media tracks with non-interactive media content;

FIG. 18 is a flow chart illustrating a method of generating disparate media tracks linked to media content;

FIG. 19 is a flow chart illustrating a method of combining disparate media tracks with non-interactive media content; and

FIG. 20 is a flow chart illustrating a method of rendering non-interactive media content including disparate media tracks.

### DETAILED DESCRIPTION OF THE PREFERRED EMBODIMENTS

System Overview:

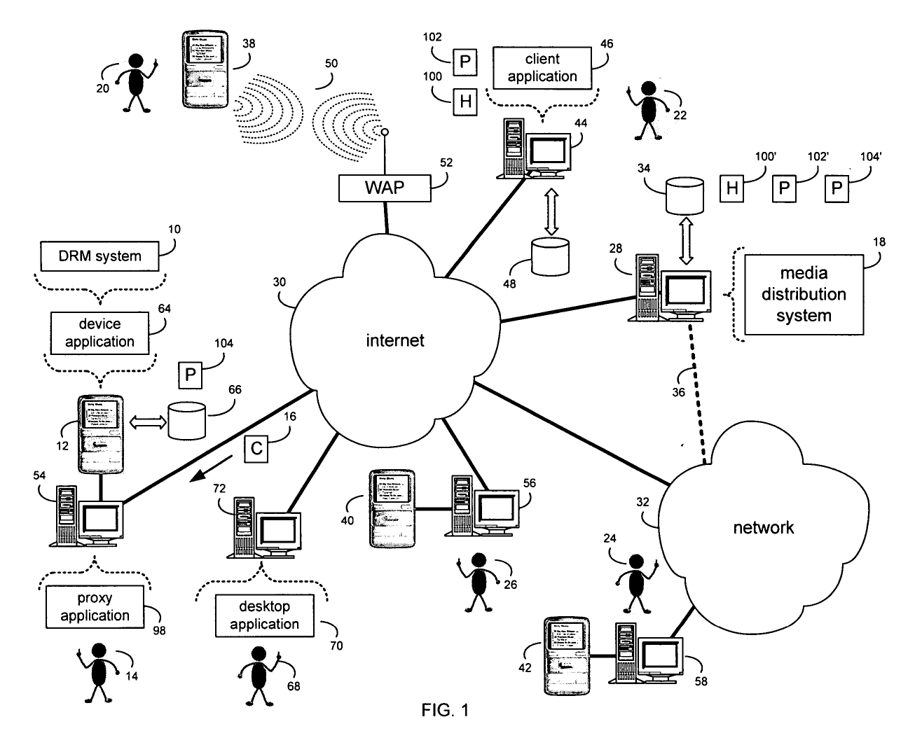

Referring to FIG. 1, there is shown a DRM (i.e., digital rights management) process 10 that is resident on and executed by personal media device 12. As will be discussed below in greater detail, DRM process 10 allows a user (e.g., user 14) of personal media device 12 to manage media content resident on personal media device 12. Personal media device 12 typically receives media content 16 from media distribution system 18.

As will be discussed below in greater detail, examples of the format of the media content 16 received from media distribution system 18 may include: purchased downloads received from media distribution system 18 (i.e., media content licensed to e.g., user 14 for use in perpetuity); subscription downloads received from media distribution system 18 (i.e., media content licensed to e.g., user 14 for use while a valid subscription exists with media distribution system 18); and media content streamed from media distribution system 18, for example. Typically, when media content is streamed from e.g., computer 28 to personal media device 12, a copy of the media content is not permanently retained on personal media device 12. In addition to media distribution system 18, media content may be obtained from other sources, examples of which may include but are not limited to files ripped from music compact discs.

Examples of the types of media content 16 distributed by media distribution system 18 include: audio files (examples of which may include but are not limited to music files, audio news broadcasts, audio sports broadcasts, and audio recordings of books, for example); video files (examples of which may include but are not limited to video footage that does not include sound, for example); audio/video files (examples of which may include but are not limited to a/v news broadcasts, a/v sports broadcasts, feature-length movies and movie clips, music videos, and episodes of television shows, for example); and multimedia content (examples of which may include but are not limited to interactive presentations and slideshows, for example).

Media distribution system 18 typically provides media data streams and/or media data files to a plurality of users (e.g., users 14, 20, 22, 24, 26). Examples of such a media distribution system 18 may include the Rhapsody™ service offered by RealNetworks, Inc. of Seattle, Wash.

Media distribution system 18 is typically a server application that resides on and is executed by computer 28 (e.g., a server computer) that is connected to network 30 (e.g., the Internet). Computer 28 may be a web server running a network operating system, examples of which may include but are not limited to Microsoft Windows 2000 Server™, Novell Netware™, or Redhat Linux™.

Typically, computer 28 also executes a web server application, examples of which may include but are not limited to Microsoft IIS™, Novell Webserver™, or Apache Webserver™, that allows for HTTP (i.e., HyperText Transfer Protocol) access to computer 28 via network 30. Network 30 may be connected to one or more secondary networks (e.g., network 32), such as: a local area network; a wide area network; or an intranet, for example.

The instruction sets and subroutines of media distribution system 18, which are typically stored on a storage device 34 coupled to computer 28, are executed by one or more processors (not shown) and one or more memory architectures (not shown) incorporated into computer 28. Storage device 34 may include but are not limited to a hard disk drive, a tape drive, an optical drive, a RAID array, a random access memory (RAM), or a read-only memory (ROM).

Users 14, 20, 22, 24, 26 may access media distribution system 18 directly through network 30 or through secondary network 32. Further, computer 28 (i.e., the computer that executes media distribution system 18) may be connected to network 30 through secondary network 32, as illustrated with phantom link line 36.

Users 14, 20, 22, 24, 26 may access media distribution system 18 through various client electronic devices, examples of which may include but are not limited to personal media devices 12, 38, 40, 42, client computer 44, personal digital assistants (not shown), cellular telephones (not shown), televisions (not shown), cable boxes (not shown), internet radios (not shown), or dedicated network devices (not shown), for example.

The various client electronic devices may be directly or indirectly coupled to network 30 (or network 32). For example, client computer 44 is shown directly coupled to network 30 via a hardwired network connection. Further, client computer 44 may execute a client application 46 (examples of which may include but are not limited to Microsoft Internet Explorer™, Netscape Navigator™, RealRhapsody™ client, RealPlayer™ client, or a specialized interface) that allows e.g., user 22 to access and configure media distribution system 18 via network 30 (or network 32). Client computer 44 may run an operating system, examples of which may include but are not limited to Microsoft Windows™, or Redhat Linux™.

The instruction sets and subroutines of client application 46, which are typically stored on a storage device 48 coupled to client computer 44, are executed by one or more processors (not shown) and one or more memory architectures (not shown) incorporated into client computer 44. Storage device 48 may include but are not limited to a hard disk drive, a tape drive, an optical drive, a RAID array, a random access memory (RAM), or a read-only memory (ROM).

As discussed above, the various client electronic devices may be indirectly coupled to network 30 (or network 32). For example, personal media device 38 is shown wireless coupled to network 30 via a wireless communication channel 50 established between personal media device 38 and wireless access point (i.e., WAP) 52, which is shown directly coupled to network 30. WAP 52 may be, for example, an IEEE 802.11a, 802.11b, 802.11g, Wi-Fi, and/or Bluetooth device that is capable of establishing the secure communication channel 50 between personal media device 38 and WAP 52. As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

In addition to being wirelessly coupled to network 30 (or network 32), personal media devices may be coupled to network 30 (or network 32) via a proxy computer (e.g., proxy computer 54 for personal media device 12, proxy computer 56 for personal media device 40, and proxy computer 58 for personal media device 42, for example).

Personal Media Device:

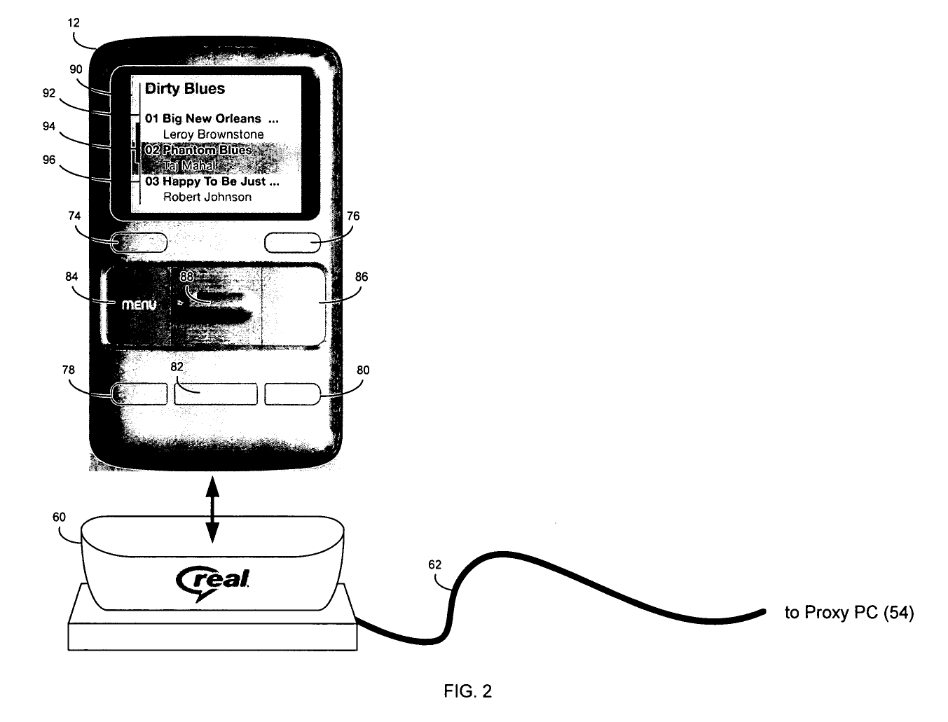

For example and referring also to FIG. 2, personal media device 12 may be connected to proxy computer 54 via a docking cradle 60. Typically, personal media device 12 includes a bus interface (to be discussed below in greater detail) that couples personal media device 12 to docking cradle 60. Docking cradle 60 may be coupled (with cable 62) to e.g., a universal serial bus (i.e., USB) port, a serial port, or an IEEE 1394 (i.e., FireWire) port included within proxy computer 54. For example, the bus interface included within personal media device 12 may be a USB interface, and docking cradle 60 may function as a USB hub (i.e., a plug-and-play interface that allows for “hot” coupling and uncoupling of personal media device 12 and docking cradle 60).

Proxy computer 54 may function as an Internet gateway for personal media device 12. Accordingly, personal media device 12 may use proxy computer 54 to access media distribution system 18 via network 30 (and network 32) and obtain media content 16. Specifically, upon receiving a request for media distribution system 18 from personal media device 12, proxy computer 54 (acting as an Internet client on behalf of personal media device 12), may request the appropriate web page/service from computer 28 (i.e., the computer that executes media distribution system 18). When the requested web page/service is returned to proxy computer 54, proxy computer 54 relates the returned web page/service to the original request (placed by personal media device 12) and forwards the web page/service to personal media device 12. Accordingly, proxy computer 54 may function as a conduit for coupling personal media device 12 to computer 28 and, therefore, media distribution system 18.

Further, personal media device 12 may execute a device application 64 (examples of which may include but are not limited to RealRhapsody™ client, RealPlayer™ client, or a specialized interface). Personal media device 12 may run an operating system, examples of which may include but are not limited to Microsoft Windows CE™, Redhat Linux™, Palm OS™, or a device-specific (i.e., custom) operating system.

DRM process 10 is typically a component of device application 64 (examples of which may include but are not limited to an embedded feature of device application 64, a software plug-in for device application 64, or a stand-alone application called from within and controlled by device application 64). The instruction sets and subroutines of device application 64 and DRM process 10, which are typically stored on a storage device 66 coupled to personal media device 12, are executed by one or more processors (not shown) and one or more memory architectures (not shown) incorporated into personal media device 12. Storage device 66 may be, for example, a hard disk drive, an optical drive, a random access memory (RAM), a read-only memory (ROM), a CF (i.e., compact flash) card, an SD (i.e., secure digital) card, a SmartMedia card, a Memory Stick, and a MultiMedia card, for example.

An administrator 68 typically accesses and administers media distribution system 18 through a desktop application 70 (examples of which may include but are not limited to Microsoft Internet Explorer™, Netscape Navigator™, or a specialized interface) running on an administrative computer 72 that is also connected to network 30 (or network 32).

The instruction sets and subroutines of desktop application 70, which are typically stored on a storage device (not shown) coupled to administrative computer 72, are executed by one or more processors (not shown) and one or more memory architectures (not shown) incorporated into administrative computer 72. The storage device (not shown) coupled to administrative computer 72 may include but are not limited to a hard disk drive, a tape drive, an optical drive, a RAID array, a random access memory (RAM), or a read-only memory (ROM).

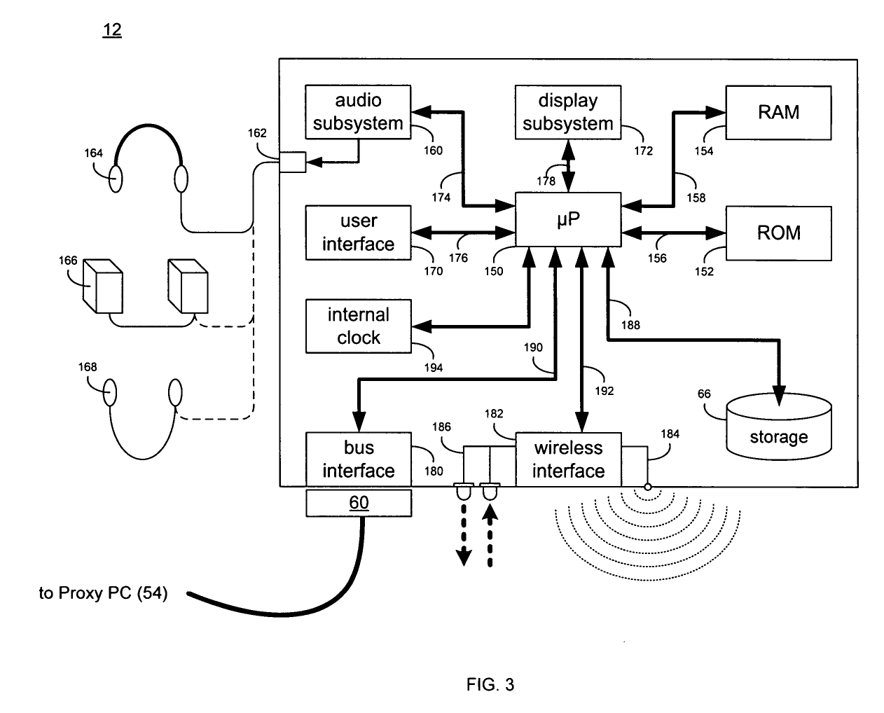

Referring also to FIG. 3, a diagrammatic view of personal media device 12 is shown. Personal media device 12 typically includes microprocessor 150, non-volatile memory (e.g., read-only memory 152), and volatile memory (e.g., random access memory 154); each of which is interconnected via one or more data/system buses 156, 158. Personal media device 12 may also include an audio subsystem 160 for providing e.g., an analog audio signal to an audio jack 162 for removably engaging e.g., a headphone assembly 164, a remote speaker assembly 166, or an ear bud assembly 168, for example. Alternatively, personal media device 12 may be configured to include one or more internal audio speakers (not shown).

Personal media device 12 may also include a user interface 170 and a display subsystem 172. User interface 170 may receive data signals from various input devices included within personal media device 12, examples of which may include (but are not limited to): rating switches 74, 76; backward skip switch 78; forward skip switch 80; play/pause switch 82; menu switch 84; radio switch 86; and slider assembly 88, for example. Display subsystem 172 may provide display signals to display panel 90 included within personal media device 12. Display panel 90 may be an active matrix liquid crystal display panel, a passive matrix liquid crystal display panel, or a light emitting diode display panel, for example.

Audio subsystem 160, user interface 170, and display subsystem 172 may each be coupled with microprocessor 150 via one or more data/system buses 174, 176, 178 (respectively).

During use of personal media device 12, display panel 90 may be configured to display e.g., the title and artist of various pieces of media content 92, 94, 96 stored within personal media device 12. Slider assembly 88 may be used to scroll upward or downward through the list of media content stored within personal media device 12. When the desired piece of media content is highlighted (e.g., “Phantom Blues” by “Taj Mahal”), user 14 may select the media content for rendering using play/pause switch 82. User 14 may skip forward to the next piece of media content (e.g., “Happy To Be Just . . . ” by “Robert Johnson”) using forward skip switch 80; or skip backward to the previous piece of media content (e.g., “Big New Orleans . . . ” by “Leroy Brownstone”) using backward skip switch 78. Additionally, user 14 may rate the media content as they listen to it by using rating switches 74, 76.

As discussed above, personal media device 12 may include a bus interface 180 for interfacing with e.g., proxy computer 54 via docking cradle 60. Additionally and as discussed above, personal media device 12 may be wireless coupled to network 30 via a wireless communication channel 50 established between personal media device 12 and e.g., WAP 52. Accordingly, personal media device 12 may include a wireless interface 182 for wirelessly-coupling personal media device 12 to network 30 (or network 32) and/or other personal media devices. Wireless interface 182 may be coupled to an antenna assembly 184 for RF communication to e.g., WAP 52, and/or an IR (i.e., infrared) communication assembly 186 for infrared communication with e.g., a second personal media device (such as personal media device 40). Further and as discussed above, personal media device 12 may include a storage device 66 for storing the instruction sets and subroutines of device application 64 and DRM process 10. Additionally, storage device 66 may be used to store media data files downloaded from media distribution system 18 and to temporarily store media data streams (or portions thereof) streamed from media distribution system 18.

Storage device 66, bus interface 180, and wireless interface 182 may each be coupled with microprocessor 150 via one or more data/system buses 188, 190, 192 (respectively).

As discussed above, media distribution system 18 distributes media content to users 14, 20, 22, 24, 26, such that the media content distributed may be in the form of media data streams and/or media data files. Accordingly, media distribution system 18 may be configured to only allow users to download media data files. For example, user 14 may be allowed to download, from media distribution system 18, media data files (i.e., examples of which may include but are not limited to MP3 files or AAC files), such that copies of the media data file are transferred from computer 28 to personal media device 12 (being stored on storage device 66).

Alternatively, media distribution system 18 may be configured to only allow users to receive and process media data streams of media data files. For example, user 22 may be allowed to receive and process (on client computer 44) media data streams received from media distribution system 18. As discussed above, when media content is streamed from e.g., computer 28 to client computer 44, a copy of the media data file is not permanently retained on client computer 44.

Further, media distribution system 18 may be configured to allow users to receive and process media data streams and download media data files. Examples of such a media distribution system include the Rhapsody™ and Rhapsody-to-Go™ services offered by RealNetworks™ of Seattle, Wash. Accordingly, user 14 may be allowed to download media data files and receive and process media data streams from media distribution system 18. Therefore, copies of media data files may be transferred from computer 28 to personal media device 12 (i.e., the received media data files being stored on storage device 66); and streams of media data files may be received from computer 28 by personal media device 12 (i.e., with portions of the received stream temporarily being stored on storage device 66). Additionally, user 22 may be allowed to download media data files and receive and process media data streams from media distribution system 18. Therefore, copies of media data files may be transferred from computer 28 to client computer 44 (i.e., the received media data files being stored on storage device 48); and streams of media data files may be received from computer 28 by client computer 44 (i.e., with portions of the received streams temporarily being stored on storage device 48).

Typically, in order for a device to receive and process a media data stream from e.g., computer 28, the device must have an active connection to computer 28 and, therefore, media distribution system 18. Accordingly, personal media device 38 (i.e., actively connected to computer 28 via wireless channel 50), and client computer 44 (i.e., actively connected to computer 28 via a hardwired network connection) may receive and process media data streams from e.g., computer 28.

As discussed above, proxy computers 54, 56, 58 may function as a conduit for coupling personal media devices 12, 40, 42 (respectively) to computer 28 and, therefore, media distribution system 18. Accordingly, when personal media devices 12, 40, 42 are coupled to proxy computers 54, 56, 58 (respectively) via e.g., docking cradle 60, personal media devices 12, 40, 42 are actively connected to computer 28 and, therefore, may receive and process media data streams provided by computer 28.

User Interfaces:

As discussed above, media distribution system 18 may be accessed using various types of client electronic devices, which include but are not limited to personal media devices 12, 38, 40, 42, client computer 44, personal digital assistants (not shown), cellular telephones (not shown), televisions (not shown), cable boxes (not shown), internet radios (not shown), or dedicated network devices (not shown), for example. Typically, the type of interface used by the user (when configuring media distribution system 18 for a particular client electronic device) will vary depending on the type of client electronic device to which the media content is being streamed/downloaded.

For example, as the embodiment shown (in FIG. 2) of personal media device 12 does not include a keyboard and the display panel 90 of personal media device 12 is compact, media distribution system 18 may be configured for personal media device 12 via proxy application 98 executed on proxy computer 54.

The instruction sets and subroutines of proxy application 98, which are typically stored on a storage device (not shown) coupled to proxy computer 54, are executed by one or more processors (not shown) and one or more memory architectures (not shown) incorporated into proxy computer 54. The storage device (not shown) coupled to proxy computer 54 may include but are not limited to a hard disk drive, a tape drive, an optical drive, a RAID array, a random access memory (RAM), or a read-only memory (ROM).

Additionally and for similar reasons, personal digital assistants (not shown), cellular telephones (not shown), televisions (not shown), cable boxes (not shown), internet radios (not shown), and dedicated network devices (not shown) may use proxy application 98 executed on proxy computer 54 to configure media distribution system 18.

Further, the client electronic device need not be directly connected to proxy computer 54 for media distribution system 18 to be configured via proxy application 98. For example, assume that the client electronic device used to access media distribution system 18 is a cellular telephone. While cellular telephones are typically not physically connectable to e.g., proxy computer 54, proxy computer 54 may still be used to remotely configure media distribution system 18 for use with the cellular telephone. Accordingly, the configuration information (concerning the cellular telephone) that is entered via e.g., proxy computer 54 may be retained within media distribution system 18 (on computer 28) until the next time that the user accesses media distribution system 18 with the cellular telephone. At that time, the configuration information saved on media distribution system 18 may be downloaded to the cellular telephone.

For systems that include keyboards and larger displays (e.g., client computer 44), client application 46 may be used to configure media distribution system 18 for use with client computer 44.

Various systems and methods of presenting media content are described below. Each of these systems and methods may be implemented on a client electronic device (e.g., a personal media device 12, a client computer 44 and/or a proxy computer 54) and in connection with a media distribution system 18 (see FIG. 1), for example, as described above. The systems and methods may be implemented using one or more processes executed by personal media device 12, client computer 44, proxy computer 54 and/or server computer 28, for example, in the form of software, hardware, firmware or a combination thereof. Each of these systems and methods may be implemented independently of the other systems and methods described herein. As described above, personal media device 12 may include a dedicated personal media device (e.g., an MP3 player), a personal digital assistant (PDA), a cellular telephone, or other portable electronic device capable of rendering digital media data.

Searching for Text Associated with Media Content:

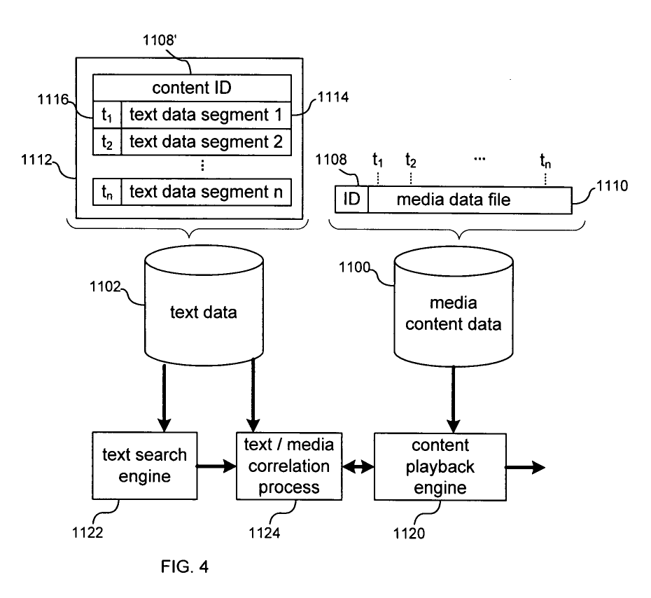

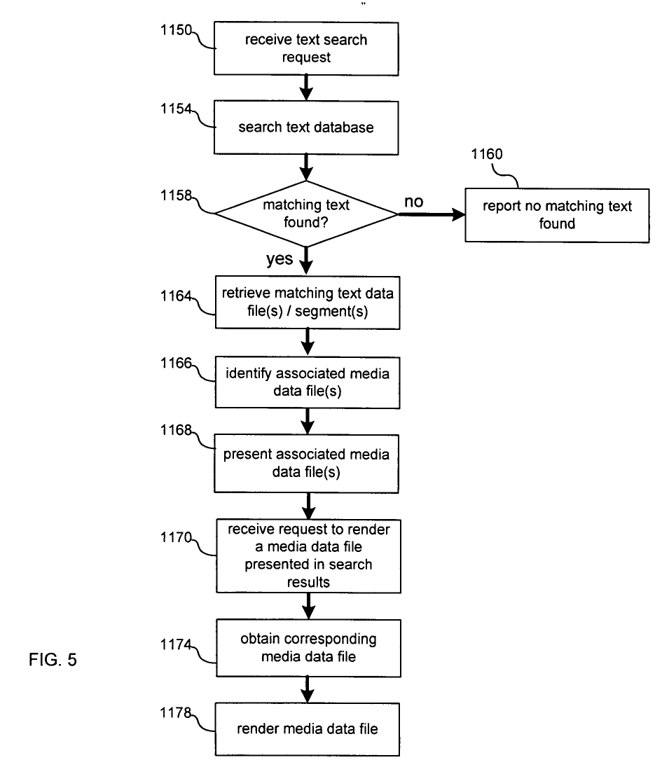

Referring to FIGS. 4-5, there is shown a system and method for searching text associated with media content. The text associated with media content may be a transcription of words in a media content item, such as, for example, lyrics associated with a song. Text associated with media content may also include dialogue associated with a movie, text associated with an audio book, or any other text associated with audio, video or audio/video media. The system and method enables a user to search for matching text (e.g., for certain song lyrics) and to obtain and render the media content data associated with the matching text.

The system and method may be implemented on a client electronic device (e.g., a personal media device 12, a client computer 44, a proxy computer 54 shown in FIG. 1) and/or a server device (e.g., server computer 28). Media content data 1100 and text data 1102 may be stored, for example, remotely (e.g., on server computer 28) or locally (e.g., on personal media device 12, client computer 44, or proxy computer 54). Media content data 1100 may include media data files such as audio data files, video data files, audio/video data files, and multimedia data files. Text data 1102 may include text data files/segments corresponding to various media data files included within media content data 1100 and may be organized and stored in a searchable datastore (not shown) using techniques known to those skilled in the art.

A media data file 1110 included within media content data 1100 may be linked to a corresponding text data file/segment 1112 included in text data 1102. Each media data file 1110 may include, for example, a content item identifier 1108 that uniquely identifies the media data file within a media distribution system (e.g., media distribution system 18). Text data file/segment 1112 may include a content item identifier 1108′ corresponding to the content item identifier 1108 in the associated media data file 1110. The text data file/segment may also be provided with the corresponding media data file 1110 as metadata, for example.

The text in text file/segment 1112 may be dynamically linked to the associated media data file 1110, such that different segments of text are associated with different playback locations within media data file 1110. In an exemplary embodiment, text segments 1114 (e.g., segment 1, segment 2, . . . segment n) within text data file/segment 1112 may include time stamps 1116 that correspond to playback positions (e.g., t₁, t₂, . . . tₙ) within media data file 1110. If t₁=0, for example, the text data segment 1 corresponds to a playback location or time at the beginning of media data file 1110. One example of linking text data to audio data is described in greater detail in U.S. Pat. No. 6,151,634, which is fully incorporated herein by reference.

Content playback engine 1120 may be resident on and executed by a client electronic device (e.g., personal media device 12, client computer 44, or proxy computer 54 shown in FIG. 1) to perform the core functions/processes associated with rendering media content (e.g., processing media data file 1110). Text search engine 1122 may be resident on and executed by either a client electronic device (e.g., personal media device 12, client computer 44, or proxy computer 54) or a server device (e.g., server computer 28) to perform the processes associated with searching for text in text data 1102. Text/media correlation process 1124 may be resident on and executed by the client electronic device (e.g., personal media device 12, client computer 44, or proxy computer 54) or a server device (e.g., server computer 28) to correlate matching text with media data files.

Content playback engine 1120, text search engine 1122, and/or text/media correlation process 1124 may be components of device application 64, client application 46 and/or media distribution system 18 (see FIG. 1), for example, as an embedded feature, software plug-in, or stand-alone application. The instruction sets and subroutines of content playback engine 1120, text search engine 1122, and text/media correlation process 1124 may be executed by one or more processors (not shown) and one or more memory architectures (not shown) (e.g., incorporated into personal media device 12, client computer 44, proxy computer 54, and/or server computer 28).

An exemplary method of searching for text associated with media content is illustrated in FIG. 5 and is described below. Text search engine 1122 may receive 1150 a text search request, for example, in the form of a search query. The user may enter the text to be searched using a client electronic device (e.g., personal media device 12, client computer 44, or proxy computer 54), which may process the text to generate and transmit the text search request to text search engine 1122. When text search engine 1122 is located on a server device (e.g., on server computer 28), the text search request may be transmitted over one or more networks 30, 32 (see FIG. 1). In one example, the text entered by the user may include one or more words from song lyrics.

In response to the text search request, text search engine 1122 may search 1154 text data 1102 for text matching the text search request. If no matching text is found 1158 in any text data files/segments in text data 1102, search engine 1122 may report 1160 no matching text. Accordingly, search engine 1122 may transmit a message to the client electronic device indicating that e.g., no text was found matching the text search request.

If matching text is found in one or more of the text data files/segments within text data 1102, search engine 1122 may retrieve 1164 the matching text data file(s)/segment(s) and may identify 1166 one or more media data files associated with the matching text data files/segments, for example, using the content item identifier 1108′ located in each matching text data file/segment 1112. The media content item(s) associated with the matching text data file/segment may be presented 1168 to the user, for example, by displaying identifying information (e.g., an indication) associated with the media data file(s) on the client electronic device. The identifying information for the media data file(s) may be located, for example, in metadata associated with the media data file(s). When searching music lyrics, for example, the identifying information may include an artist, a track, an album and other information. In one embodiment, the client electronic device may present media data file(s) together with the matching text, for example, showing the key words from the search query in context with other text from the text data file/segment.

When the matching media data file(s) are presented to the user, one or more of the matching media data file(s) may be selected by the user for rendering. Alternatively, the matching media data file(s) may be selected automatically for rendering. In either case, media content playback engine 1120 may receive 1170 a request to render the selected matching media data file(s), may obtain 1174 the corresponding media data file(s), and may render 1178 the corresponding media data file(s). To obtain the corresponding media data file(s), text/media correlation process 1124 may obtain the content item identifiers in the matching text data files/segments, and may use the content item identifiers to retrieve the associated media data file(s) from the media content data 1100.

In an exemplary embodiment, content playback engine 1120 may render the selected corresponding media data file starting at a location corresponding to the matching text. Upon receiving a playback request, for example, text/media correlation process 1124 may retrieve a playback time from a time stamp associated with the text data file/segment including the matching text. Content playback engine 1124 may then begin rendering the corresponding media data file at a point in time corresponding to the playback time obtained from the matching text data files/segments. When searching music lyrics, for example, the user may listen to the matching lyrics in context within the song without having to listen to the entire song. Alternatively/additionally, content playback engine 1120 may render the entire media data file.

In another embodiment, content playback engine 1120 may render the corresponding media data file (e.g., either from the beginning or from a point corresponding to the matching text data file/segment) while the corresponding text is displayed to the user. At relevant playback times, text/media correlation process 1124 may retrieve text data files/segments having time stamps corresponding to the playback time and may cause the corresponding text to be displayed. When playing music, for example, a user may read or sing along with the lyrics as the musical track is played.

Accordingly, a system and method for searching text associated with media content enables a user to locate and render the media content (e.g., a song) corresponding to matching text (e.g., lyrics).

Color-Based User Interface for Selecting Media Content:

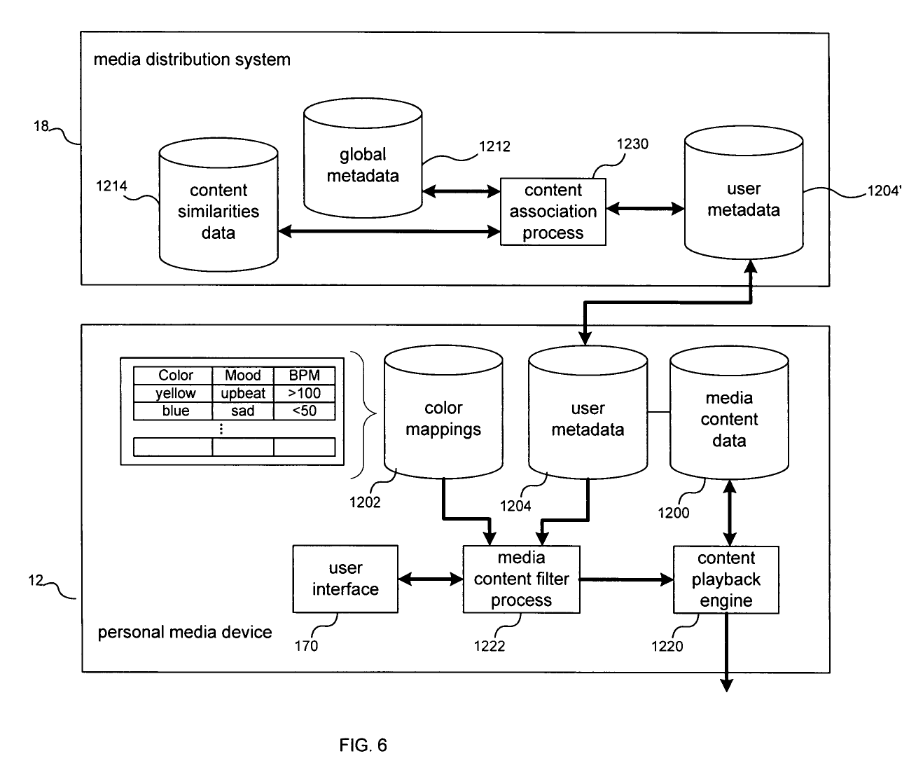

Referring to FIGS. 6-9, there is shown a system and method for providing a color-based user interface for selecting media content. Characteristics of media content may be mapped to color representations to enable a user to quickly access media content having a desired characteristic by selecting the corresponding color representation. In an exemplary embodiment, media data files may include e.g., music tracks and the characteristics may include a mood associated with the music track and/or beats-per-minute (BPM) associated with the music track. Such an interface may be particularly advantageous on a client electronic device having a limited display environment (e.g., a personal media device 12), although the color-based user interface may be implemented on any type of electronic device that renders media content. As described below in greater detail, content characteristics (e.g., moods and BPM) may be associated with media data files editorially (e.g., by a user of media distribution system 18), individually (e.g., by a user of personal media device 12), and/or algorithmically (e.g., by a content association process executed e.g., by media distribution system 18).

Media content data 1200, color mappings 1202 and user metadata 1204 may be stored on personal media device 12. Media content data 1200 may include media data files, such as audio data files, video data files, audio/video data files, and multimedia data files. Color mappings 1202 may include colors (e.g., red, yellow, blue, etc.) mapped to one or more content characteristics (e.g., mood and BPM). User metadata 1204 may include identifying information (e.g., a media data file identifier, a track name, an artist name, an album name) and content characteristics (e.g., a mood and a BPM) associated with each media data file available to personal media device 12. User metadata 1204 may include data (e.g., identifying information and/or characteristics) that has been defined by a user as well as data that has been defined by e.g., media distribution system 18. User metadata 1204 may be stored together with associated media content data 1200 (e.g. as part of a media data file). Alternatively, user metadata 1204 may be stored separately.

Media distribution system 18 may include user metadata 1204′ that includes data specific to a user (e.g., characteristics defined by the user). User metadata 1204′ may be uploaded from personal media device 12 (e.g., when docked and connected to proxy computer 54). Media distribution system 18 may also include global metadata 1212 that does not include data specific to a user (e.g., identifying information and/or characteristics defined by media distribution system 18). Media distribution system 18 may further include content similarities data 1214 defining associations/similarities between various media data files. In a music distribution system, for example, content similarities data may define similar artists (e.g., artists who are influences, contemporaries, followers, or involved in related projects) for each of the artists associated with the available media data files.

Content playback engine 1220 may be resident on and executed by a client electronic device (e.g., personal media device 12, client computer 44, and/or proxy computer 54 shown in FIG. 1) to perform the core functions or processes associated with rendering media content (e.g., processing media data files). Media content filter process 1222 may be resident on and executed by a client electronic device (e.g., personal media device 12, client computer 44, and/or proxy computer 54 shown in FIG. 1) to filter media data files based on characteristics corresponding to selected color representations. Content playback engine 1220 and media content filter process 1222 may be components of device application 64 and/or client application 46, for example, as an embedded feature, software plug-in, or stand-alone application. The instruction sets and subroutines of content playback engine 1220 and content filter process 1222 may be executed by one or more processors (not shown) and one or more memory architectures (not shown) that are incorporated into e.g., personal media device 12.

Content association process 1230 may be resident on and executed by a server device (e.g., server computer 28 shown in FIG. 1) to associate content characteristics with other data files based on user metadata 1204′ and content similarities data 1214. Content association process 1230 may be a component of media distribution system 18, for example, as an embedded feature, software plug-in, or stand-alone application. The instruction sets and subroutines of content association process 1230 may be executed by one or more processors (not shown) and one or more memory architectures (not shown) that are incorporated into e.g., server computer 28.

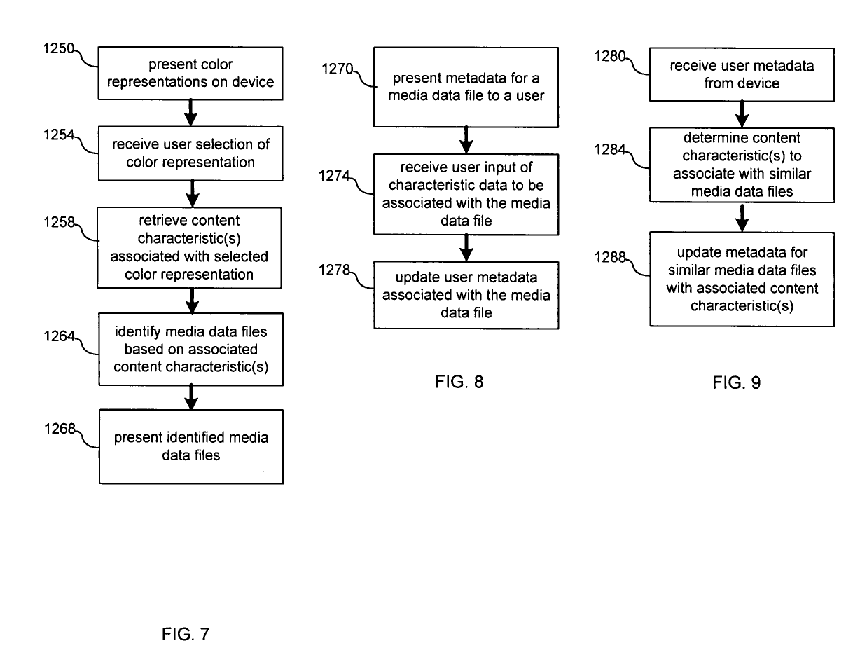

An exemplary method of providing a color-based user interface is illustrated in FIG. 7 and is described below. Personal media device 12 may present 1250 color representations to the user, for example, by displaying the color representation on display panel 90 (see FIG. 2). A color representation may include a solid color or a mix of colors (e.g., representing a mixed mood). A user interface 170 (see FIG. 3) may be used to present 1250 different color representations to the user by e.g., receiving a signal from slider assembly 88 (see FIG. 2) and causing different color representations to scroll across display panel 90 in response to received signal. When the user selects a desired color representation (e.g., using slider assembly 88), personal media device 12 may receive 1254 a user selection signal (indicative of the color representation selected) and may retrieve 1258 content characteristic data (e.g., data identifying a mood and/or BPM) associated with the selected color representation (as defined by color mappings 1202).

Personal media device 12 may then identify 1264 media data files associated with the retrieved content characteristic data mapped to the selected color representation. Media content filter process 1222 may e.g., access user metadata 1204 to retrieve media data file identifiers (e.g., which identify individual media data files) associated with a content characteristic matching the characteristic mapped to the selected color representation. Personal media device 12 may present 1268 the identified media data files with the matching content characteristic(s) to the user by displaying a playlist defining the identified media data files. Additionally/alternatively, content playback engine 1220 may automatically begin rendering the identified media data files.

According to one example, if a user selects yellow, personal media device 12 may receive 1254 the user selection and may retrieve 1258 data from color mappings 1202 to identify e.g., an upbeat mood characteristic and a BPM greater than 100. Content filter process 1222 may then access user metadata 1204 to retrieve 1258 data file identifiers (e.g., which identify individual media data files) associated with e.g., an upbeat mood characteristic and a BPM greater than 100. Thus, media data files may be filtered and presented based on content characteristics associated with the selected color representation.

An exemplary method of individually associating content characteristic data with data files is illustrated in FIG. 8 and is described below. Personal media device 12 (or proxy computer 54 shown in FIG. 1) may present 1270 user metadata 1204 associated with a selected media data file to a user. User metadata may be displayed, for example, in one or more text boxes on display panel 90 (see FIG. 2). User metadata 1204 may include identifying information and characteristics already associated with media data files (e.g., artist name, album name, track name), such as the metadata initially provided by media distribution system 18. A user may edit user metadata 1204 (e.g, using personal media device 12 or proxy computer 54) by modifying and/or adding content characteristics based on the preferences of the user. In an exemplary embodiment, a user may modify and/or add a mood associated with a musical track based on the mood evoked in the user by the musical track. When the user adds a content characteristic and/or edits the existing content characteristic associated with a data file, the personal media device 12 (or proxy computer 54) may receive 1274 the characteristic data entered by the user and may update 1278 user metadata 1204 associated with the selected media data file accordingly.

An exemplary method of algorithmically and/or automatically associating content characteristic data with data files is illustrated in FIG. 9 and is described below. Media distribution system 18 may receive 1280 user metadata 1204′ from personal media device 12 and/or proxy computer 54, for example, when personal media device 12 is docked or connected wirelessly. Media distribution system 18 may determine 1284 one or more content characteristics (e.g., moods and/or BPMs) to associate with similar media content according to the user's preferences indicated by user metadata 1204′ and content similarities data 1214. Media distribution system 18 may update 1288 metadata for similar media content (e.g., as defined using content similarities data 1214) to include the associated content characteristics.

In one example, content characteristic data may be automatically associated with new media content before transferring the new media content from media distribution system 18 to personal media device 12. Content association process 1230, for example, may identify an artist associated with the new content and may access content similarities data 1214 to identify similar artists (e.g., followers, contemporaries or influences, or related projects). Content association process 1230 may also access user metadata 1204′ to identify content characteristics (e.g., moods) the user may have associated with the artists for the new media content and/or the similar artists. Content association process 1230 may then associate the identified content characteristics with the new media content, for example, by adding the content characteristic data to the metadata for the new media data files before transmitting the new media data files to personal media device 12. For example, if the user metadata 1204′ indicates that musical tracks by artist Bob Marley are associated with an upbeat mood, an upbeat mood characteristic may be associated with other musical tracks by similar artists (e.g., as defined by content similarities data 1214).

In another example, new media content may be retrieved based on a content characteristic. Media distribution system 18 may receive content characteristic data (e.g., identifying a mood and/or BPM) from personal media device 12 or proxy computer 54 or may retrieve content characteristic data from user metadata 1204′. Content association process 1230 may access user metadata 1204′ to identify one or more data files (and the associated artist(s)) having that content characteristic. Content association process 1230 may then access content similarities data 1214 to identify similar content, for example, artists associated with the artists for the data files having the content characteristic. Content association process 1230 may then add the content characteristic data to the metadata associated with the similar data files, and media distribution system 18 may transfer the similar data files to personal media device 12. In one example, a user may request music associated with an upbeat mood (e.g., by selecting yellow on personal media device 12). In response to the request, media distribution system 18 may retrieve music similar to the music that the user has identified as upbeat, associate an upbeat mood characteristic with the similar music, and push (i.e., download) the similar music to personal media device 12.

Accordingly, the system and method of providing a color-based user interface for selecting media content facilitates user selection of media content to be rendered based on content characteristic (e.g., a mood) associated with the media content.

Presenting Media Content Chronologically with Historical Events:

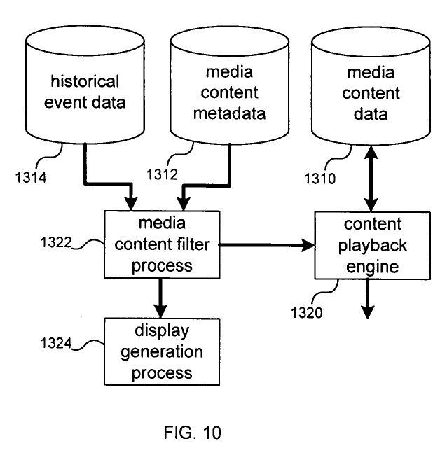

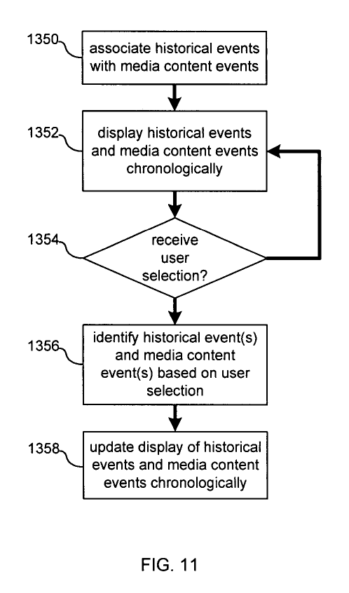

Referring to FIGS. 10-11, there is shown a system and method for presenting media content chronologically with historical events. In an exemplary embodiment, media data files may include musical tracks, although other types of media content are within the scope of this system and method. Media content events (e.g,. the release of a musical track or album) may be associated with historical events based on a date (e.g., a year in which the album/track was released). Historical events may include music related events (e.g., music festivals, concerts, artist birthdays) and non-music related events (e.g., current events).

The system and method may be implemented on a client electronic device (e.g., a personal media device 12, a client computer 44, a proxy computer 54 shown in FIG. 1) and/or on a server device (e.g., a server computer 28). Media content data 1310, media content metadata 1312 and historical event data 1314 may be stored (e.g., on personal media device 12, client computer 44, proxy computer 54, and/or server computer 28). Media content data 1310 may include media data files, such as audio files (e.g., music), video files (e.g., videos), audio/video files, and multimedia files. Media content metadata 1312 associated with each media data file (e.g., included within media content data 1310) may include, for example, an artist identifier, an album identifier, a track identifier, an album cover image, a music genre identifier, and date information (e.g., a release date) associated with the release of the track/album. Media content metadata 1312 may be stored together with media content data 1310 (e.g. as part of the related media data files) or may be stored separately from media content data 1310. Historical event data 1314 may include event information identifying and describing events and date information identifying a time period in which an event occurred, examples of such events may include historical concert tour dates (e.g., the day that Led Zeppelin started their 1972 world tour), historical general events (e.g., the explosion of the space shuttle Challenger), music-related milestones (e.g., Pink Floyd's Dark Side of the Moon became the longest album on the Billboard Charts), and economic events (e.g., the bursting of the dot corn bubble), for example.

Content playback engine 1320 and display generation process 1324 may be resident on and executed by client electronic device (e.g., personal media device 12, client computer 44, or proxy computer 54 shown in FIG. 1) to perform the core functions or processes associated with rendering media content such as processing media data files. Content playback engine 1320 and display generation process 1324 may be components of device application 64 or client application 46 (see FIG. 1), for example, as an embedded feature, software plug-in, or stand-alone application. Media content filter process 1322 may be resident on and executed by a client electronic device (e.g., personal media device 12, client computer 44, or proxy computer 54 shown in FIG. 1) or a server device (e.g., computer 28 shown in FIG. 1) to filter media data files based on an associated date. Media content filter process 1322 may be a component of device application 64, client application 46, or media distribution system 18, for example, as an embedded feature, software plug-in, or stand-alone application. The instruction sets and subroutines of content playback engine 1320, display generation process 1324, and media content filter process 1322 may be executed by one or more processors (not shown) and one or more memory architectures (not shown) (e.g., incorporated into personal media device 12, client computer 44, proxy computer 54, and/or server computer 28).

An exemplary method for presenting media content chronologically with historical events is illustrated in FIG. 11 and described in greater detail below. A client electronic device (e.g., personal media device 12, client computer 44, or proxy computer 54), may associate 1350 one or more historical events with one or more media content events (e.g., the release of a music track or album) based on a chronological relationship. For a given period or window of time, for example, media content filter process 1322 may access media content metadata 1312 and historical event data 1314 to identify media data files and historical events having an associated date within the given window of time. The given window of time may be defined initially by default or may be entered by the user. Different windows of time may be used; for example, a large window of time may cover multiple decades or a smaller window of time may cover a particular year.

The client electronic device (e.g., personal media device 12, client computer 44, or proxy computer 54 shown in FIG. 1) may display 1352 a chronological representation of the associated historical events and media content events within the given window of time e.g., along a timeline. Display generation process 1324, for example, may render a visual representation of the timeline including relevant dates and identifying information for the associated historical events and the media content events. Identifying information displayed for the associated historical events may include information items such as a name of the event and a description of the event. Identifying information for a media content event may include information items such as the name of a music track, the name of an album, the associated artist, and the genre.

The visual representation of the timeline may be an interactive representation that allows a user to select one or more information items on the timeline (e.g., presented as hyperlinks) to obtain additional information concerning the one or more information items selected. A user may select a window of time displayed on the timeline to e.g., obtain media content events and/or historical events within the selected window of time. Alternatively, a user may select an historical event to e.g., obtain media content events and/or other historical events within a window of time proximate the selected historical event. Additionally, a user may select a media content event (e.g., a name of a music track or album) to obtain other media content events and/or historical events within a window of time proximate the selected media content event. Further, a user may select media metadata (e.g., an artist name or genre) to obtain media content events and/or historical events associated with the selected media metadata.

Upon receiving a user selection 1354 of an informational item on the timeline (e.g., a window of time, an historical event, a media content event, or media metadata), additional media content events and/or historical events may be identified 1356 based on the informational item selected 1354 by the user. Display generation process 1324 may update 1358 the display to show the additional media content events and/or historical events e.g. within a new window of time. Accordingly, system and method thus allows a user to e.g. “zoom in” on different windows of time and/or to filter the events displayed on the timeline (e.g., based on artist name or genre).

If a user selects a window of time, media content filter process 1322 may e.g. access media content metadata 1312 and historical event data 1314 to identify media content events and/or historical events having an associated date corresponding to the selected window of time. If a user selects an historical event, media content filter 1322 may access media content metadata 1312 and historical event data 1314 to identify media content events and/or historical events having an associated date within a window of time proximate the selected historical event. If a user selects a media content event, media content filter 1322 may access media content metadata 1312 and historical event data 1314 to identify media content events and historical events having an associated date within a window of time proximate the selected media content event. The display may then be updated to show the new window of time and the media content events and historical events proximate the selected historical event/media content event.

If a user selects an artist name or genre, media content filter 1322 may access media content metadata 1312 and historical event data 1314 to identify media content events associated with the selected artist name or genre and historical events having an associated date within a window of time proximate the media data files associated with the selected artist name or genre. The display may be updated to show only media content events associated with the selected artist name or genre and the historical events chronologically associated with those media content events.

Accordingly, a system and method for presenting media content chronologically with historical events enables a user to view media content such as music from a perspective of windows of time with other historical events that occurred within the windows of time.

Establishing Non-Interactive Media Content Based on User Metadata:

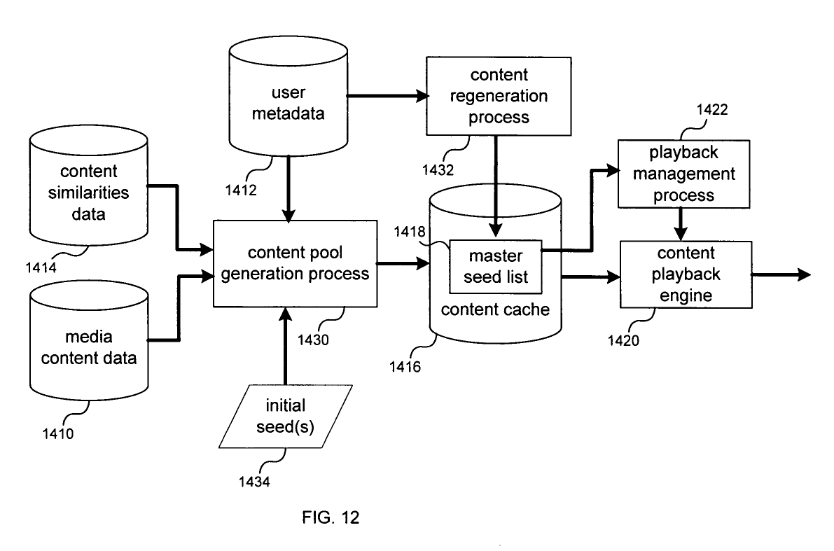

Referring to FIGS. 12-14, there is shown a system and method for establishing non-interactive media content based on user metadata. Non-interactive media content (also referred to as radio content) may be used to generate a non-interactive media content playback (also referred to as a radio station) on an electronic device. Media content playback generally refers to the rendering on the electronic device of multiple media content items in a sequence. In an exemplary embodiment, media content items include music tracks, although other types of content items (e.g., videos or movies) may be used in a media content playback.

As used herein, non-interactive means not allowing a user to request a particular content item to be rendered. A non-interactive media content playback may include a plurality of content items selected and arranged randomly or pseudo-randomly for rendering. Non-interactive media content playback may allow some level of user control over playback. For example, a user may start and stop the playback or may skip content items within certain restrictions, as will be described in greater detail below. A user may also suggest the general nature of the content to be included in the content playback. In a non-interactive music content playback or radio station, for example, a user may suggest a musical artist or a genre of music, which may form the basis for randomly or pseudo-randomly selecting content items for playback.

In an exemplary embodiment, non-interactive media content playback may be configured to comply with certain playback requirements, such as the Digital Millennium Copyright Act (“DMCA”). The DMCA includes statutory requirements governing the digital performance of certain sound recordings including, inter alia, the sound recording performance complement restricting the number of times a song, artist, or group of artists may be rendered within a specified time interval. Presently and more specifically, the sound recording performance complement is the transmission, during any three-hour period, of no more than: (A) three different selections of sound recordings from a particular phonorecord (i.e., album), if no more than two such selections are transmitted consecutively; or (B) four different selections of sound recordings by the same recording artist or from any set or compilation of phonorecords (i.e. anthology), if no more than three such selections are transmitted consecutively. Audio and video playback in compliance with performance complement requirements is described for example, in U.S. Pat. No. 6,611,813, which is fully incorporated herein by reference.

Although the exemplary embodiment of non-interactive media content playback may be configured to comply with DMCA requirements, this is not a limitation of the system and method described herein. The Copyright laws, the policies of the American Society of Composers, Authors, and Publishers (ASCAP), and the policies of Broadcast Music, Inc. (BMI) may also define other playback requirements for media content.

The system and method of establishing non-interactive media content based on user metadata may be implemented on a client electronic device (e.g., personal media device 12, client computer 44, or proxy computer 54 shown in FIG. 1) and/or a server device (e.g., computer 28 shown in FIG. 1). Media content data 1410 and content similarities data 1414 may be stored, for example, on server computer 28. Media content data 1410 may include media data files (e.g., audio data files, video data files, audio/visual files, and multimedia data files) corresponding to media content items (e.g., music tracks). Media content data 1410 provides the media content for generating non-interactive media content. Content similarities data 1414 may include data defining associations between media content that has been determined to be similar. In a music distribution system, for example, content similarities data 1414 may define similar artists (e.g., artists who are influences, contemporaries, followers or involved in related projects) for each of the artists associated with the available songs.

User metadata 1412 may be stored on a client electronic device (e.g., personal media device 12, client computer 44, or proxy computer 54) and may be transferred to server computer 28. User metadata 1412 may be associated with each media content item (on a per-user basis) to track e.g., listening trends and musical preferences of individual users and may include, for example, a user rating, a play count, and a last played date/time. User metadata 1412 may be stored together with an associated media data file or may be stored separately. In general, metadata may also include other data associated with each media content item such as an artist identifier, an album identifier, a track identifier, an album cover image, a music genre identifier, and a content item identifier that uniquely identifies a content item within a music distribution service. One example of a system and method of managing metadata data is described in greater detail in U.S. Pat. No. 6,760,721, which is fully incorporated herein by reference.

A non-interactive content cache 1416 may be stored on a client electronic device (e.g., on personal media device 12, client computer 44, or proxy computer 54) with a master seed list 1418 defining an initial sequence in which content items are to be rendered. The master seed list 1418 may define a sequence for all content items in the content cache 1416 or the content cache 1416 may include “surplus” content items, which are not identified in the master seed list 1418. Non-interactive content cache 1416 may be constructed from media content data 1410 and may include one or more media data files in a scrambled file format. Master seed list 1418 may include content item identifiers mapped to each of the scrambled media data files in content cache 1416. Alternatively, non-interactive media content may be streamed (i.e., without constructing a content cache) from media distribution system 18 to a client electronic device (e.g., personal media device 12 or computer 44, 54) for buffering and rendering.

Content playback engine 1420 may be resident on and executed by a client electronic device (e.g., personal media device 12, client computer 44, or proxy computer 54 shown in FIG. 1) to perform the core functions or processes associated with rendering media content such as processing media data files. Playback management process 1422 may be resident on and executed by either a client electronic device (e.g., personal media device 12, client computer 44, or proxy computer 54 shown in FIG. 1) or a server device (e.g., server computer 28 shown in FIG. 1) to manage playback of non-interactive media content, for example, to maintain compliance with DMCA performance complement requirements. Content pool generation process 1430 may be resident on and executed by server computer 28 to generate the content pool and master seed list to be used in a non-interactive media content playback. Regeneration process 1432 may be resident on and executed by the client electronic device (e.g., personal media device 12, client computer 44, or proxy computer 54) to regenerate the content pool and master seed list for used in non-interactive media content playback (e.g., by adding/removing content items and/or changing the playback sequence).

Content playback engine 1420, playback management process 1422 and content regeneration process 1432 may be components of device application 64 or client application 46 (see FIG. 1), for example, as an embedded feature, software plug-in, or stand-alone application. Content pool generation process 1430 may be a component of media distribution system 18, for example, as an embedded feature, software plug-in, or stand-alone application. The instruction sets and subroutines of content playback engine 1420, playback management process 1422, content pool generation process 1430, and content regeneration process 1432 may be executed by one or more processors (not shown) and one or more memory architectures (not shown) (e.g., incorporated into personal media device 12, client computer 44, proxy computer 54, and/or server computer 28).

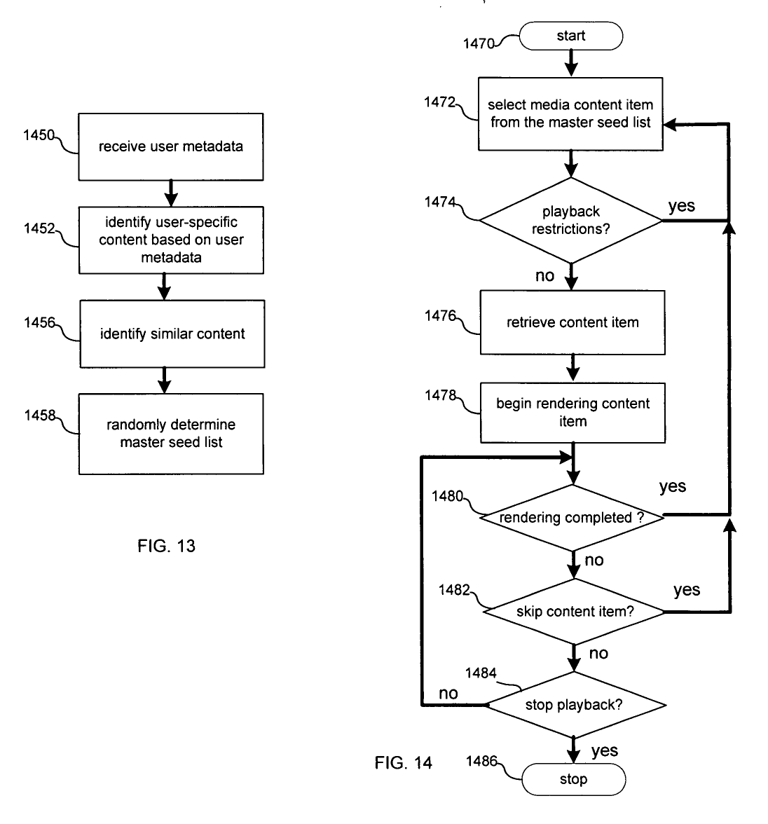

An exemplary method of establishing non-interactive media content based on user metadata is illustrated in FIG. 13 and described below. The content generating device (e.g., server computer 28) may receive 1450 user metadata 1412. User metadata 1412 may be compiled and saved as the user renders media content by automatically recording a play count and a last played date/time for a content item and/or by receiving user input of a user rating for the content item. In an exemplary embodiment where server computer 28 includes content pool generation process 1430, user metadata 1412 may be generated by and transmitted from a client electronic device to server computer 28.

The content generating device may then identify 1452 user-specific media content items based on user metadata 1412. User-specific media content items may be preferred content items that a user prefers (e.g,. rated high, played frequently, or played recently) and/or may include non-preferred content items that a user does not prefer (e.g., rated low or played infrequently). Content pool generation process 1430, for example, may access user metadata 1412 to obtain ratings, play counts, and last played dates/times and to identify the user-specific media content items (e.g., by content item identifier). As described below, the user-specific media content items may be used to establish the non-interactive media content, for example, by including preferred content and/or by excluding non-preferred content.

The content generating device may also identify 1456 similar media content items that are similar to user-specific media content items. Similar content may include content from the same genre or content from artists that have been previously identified as being similar. Content pool generation process 1430, for example, may access content similarities data 1414 to identify similar artists (e.g., influences, contemporaries, followers, or related projects) associated with the artists for the user-specific content items. Content items for those similar artists are thus identified as similar content items. If a user has entered a high rating for a song by Elvis, for example, content pool generation process 1430 may identify other similar artists associated with Elvis and songs by those other associated artists may be identified as similar.

The content generating device may then randomly determine 1458 a master seed list 1458 for the non-interactive content playback taking into account the user-specific content. The master seed list 1458 may include preferred content items (and content items similar to preferred content items) and/or exclude non-preferred content items (and content items similar to non-preferred content items). Thus, the random seed pool used for non-interactive media content may be modified based on the user metadata. The master seed list may define a sequence of content items that complies with any playback requirements such as DMCA performance complement requirements. The number of content items included in a master seed list may also depend on playback requirements, such as DMCA requirements, and may be at least 300 content items in one example.

In one exemplary embodiment, user-specific content (as determined from user metadata) may be used to establish the non-interactive media content (and master seed list) when generating the initial non-interactive content cache 1416 or stream of non-interactive content. Media distribution system 18 and/or proxy computer 54 may establish non-interactive media content, for example, upon receiving a request from personal media device 12 for non-interactive media content. To generate the non-interactive cache 1416, content pool generation process 1430 may receive initial seeds 1434 for generating non-interactive media content. Initial seeds may be used to establish initial seed content as a starting point or basis for the non-interactive media content. Initial seeds may include, for example, one or more artist names or genres and initial seed content may include content items associated with those artist names or genres. Initial seeds may be provided by the user (e.g., by entering one or more artist names or genres) or may be provided by a media distribution service (e.g., an editor or program manager may select a genre or artists associated with a particular genre or theme). The artists or genres associated with preferred content items identified from user metadata may also be used as the initial seeds.

Content pool generation process 1430 may then identify similar media content items that are similar to initial seed content items, for example, by accessing content similarities data 1414. Similar content may include content from the same genre or content from artists that have been previously identified as being similar. Content pool generation process 1430 may then randomly select content items (e.g., initial seed content items, user preferred content items, and similar content items) for inclusion in master seed list 1418. In randomly selecting content items, content pool generation process 1430 may also exclude non-preferred content items, as described above.

The randomly selected content items may be arranged in a sequence in master seed list 1418 that complies with any playback requirements such as DMCA performance complement requirements. Content pool generation process 1430, for example, may track data for all non-interactive media content added to master seed list 1418 (e.g., the artist name and the album name) and may check or test each content item against the tracked data before adding the content item to the master seed list 1418. One example of such performance complement testing is described in greater detail in U.S. Pat. No. 6,611,813, which is fully incorporated herein by reference.

Once content items (e.g., initial seed content and similar content) have been identified, content pool generation process 1430 may construct non-interactive content cache 1416 using the media data files for the identified content items. Media distribution system 18 and/or proxy computer 54 may construct the content cache 1416, for example, when personal media device 12 is not communicating with media distribution system 18 or proxy computer 54. When communication is established between personal media device 12 and media distribution system 18 or proxy computer 54 (e.g., by docking or wireless communication), the constructed content cache 1416 and master seed list 1418 may be pushed down to personal media device 12. Alternatively, content cache 1416 may be constructed directly on personal media device 12 if personal media device 12 communicates with media distribution system 18 or proxy computer 54 for a sufficient period of time.

According to another alternative, non-interactive content established from user-specific content may be streamed to personal media device 12, for example, if personal media device 12 establishes a substantially continuous communication with media distribution system 18. In this alternative embodiment, non-interactive content data may be transferred in pieces and buffered on personal media device 12 without transmitting the entire content cache 1416 and master seed list 1416 to personal media device 12.

In another exemplary embodiment user-specific content may be used to establish the non-interactive media content (and master seed list) when regenerating non-interactive content cache 1416 and master seed list 1418. Non-interactive media content may be regenerated, for example, to take into account user-specific content and/or to remain DMCA compliant. To regenerate non-interactive media content, content regeneration process 1432 may add and/or remove content items and may change the sequence of the content items to remain compliant with playback requirements such as DMCA performance complement requirements, as described above. More specifically, content regeneration process 1432 may remove non-preferred media content items (and/or media content items similar to non-preferred media content items) and may add preferred media content items (and/or media content items similar to preferred media content items). Content items that a user has rated low, for example, may be removed from the content pool and replaced with content items that are similar to content items rated high by the user. Content items may be added to master seed list 1418 from “surplus” content items in the non-interactive content cache 1416. Alternatively, personal media device 12 may send a request to media distribution system 18 for additional media content data 1410, and media distribution system 18 and/or proxy computer 54 may construct a new content cache 1416 and master seed list 1418.

An exemplary method of rendering non-interactive media content to provide a non-interactive media content playback is illustrated in FIG. 14 and described below. A rendering device (e.g., personal media device 12) may start 1470 playback of non-interactive media content, for example, when a user activates radio switch 86 on personal media device 12 (see FIG. 2). Upon starting playback, the rendering device (or alternatively the media distribution system if streaming) may select 1472 a media content item from master seed list 1418. The rendering device may select content items sequentially such that a first playback may start with a first content item in master seed list 1418 and subsequent playbacks (e.g., when a playback has been stopped and started again) may start with a next available content item following the last content item selected from the master seed list 1418 during the last playback. Playback management process 1422, for example, may track content items that have been selected for playback to prevent the same content item from being selected again when playback is stopped and started. Playback management process 1422 may thus ensure compliance with DMCA requirements by preventing a user from having an advanced notice of the next content item to be rendered.

After selecting a media content item, the rendering device (or alternatively the media distribution system if streaming) may determine 1474 if any playback restrictions (e.g., performance complement restrictions) would prevent the selected content item from being rendered at that point in the sequence. Playback management process 1422, for example, may track data for all non-interactive media content that is rendered (e.g., the artist name and the album name) and may check or test each content item against the tracked data. One example of such performance complement testing is described in greater detail in U.S. Pat. No. 6,611,813, which is fully incorporated herein by reference. If personal media device 12 includes a content cache 1416, playback management process 1422 may be executed by personal media device 12. If non-interactive content data is streamed to the rendering device from media distribution system 18, playback management process 1422 may be executed by media distribution system 18.

If playback restrictions prevent the content item from being rendered, another media content item (e.g., the next item in the content seed list) may be selected 1472 and tested 1474 for compliance. If playback restrictions do not prevent the content item from being rendered, the rendering device (e.g., personal media device 12) may retrieve 1476 the content item. Content playback engine 1420, for example, may use the content identifier from the master seed list to locate and retrieve the corresponding media data file from non-interactive content cache 1416. Content playback engine 1420 may then begin rendering 1478 the media data file retrieved for the content item.

Alternatively, if non-interactive media content is streamed to the rendering device, media distribution system 18 may retrieve media data files from media content data 1410. Content playback engine 1420 may then receive and render pieces of the media data file as they are streamed.

Content playback engine 1420 may continue to render the media data file until content playback engine 1420 determines that rendering is completed 1480, the content item is skipped 1482, or playback is stopped 1484. A user may skip a content item, for example, by activating a forward skip switch 80 on personal media device 12 (see FIG. 2). Playback management process 1422 may monitor and limit the number of skips, for example, to comply with playback requirements that limit the number of allowed skips. In one embodiment, a predetermined number of skips (e.g., 30) may be allowed during a single playback. If rendering of the media data file is completed or the content item is skipped, another content item (e.g., the next in the sequence) may be selected and the process repeats. If a user stops playback, the rendering process stops 1486. As discussed above, the playback may be re-started with the next available content item in the master seed list 1418.

As the non-interactive media content playback is stopped and started, the playback may continue selecting sequential content items from the same master seed list 1418 until the non-interactive content (and master seed list 1418) is regenerated, as described above. In one example, a particular sequence of media data files as defined by master seed list 1418 may only be played once in that particular order and then must be regenerated to comply with DMCA requirements.

According to another alternative, the non-interactive media content may be re-generated “on-the-fly” during the non-interactive media content playback. Content pool generation process 1430, for example, may add and/or remove content items from the content pool and master seed list 1418 based on the user specific content identified from user metadata, as described above, while the content playback engine 1420 renders content items in the master seed list 1418.

Accordingly, non-interactive media (or radio) content playback may be tuned or refined based on user metadata that tracks the user's preferences and activities while still complying with playback requirements.

Local Generation of Non-Interactive Media Content:

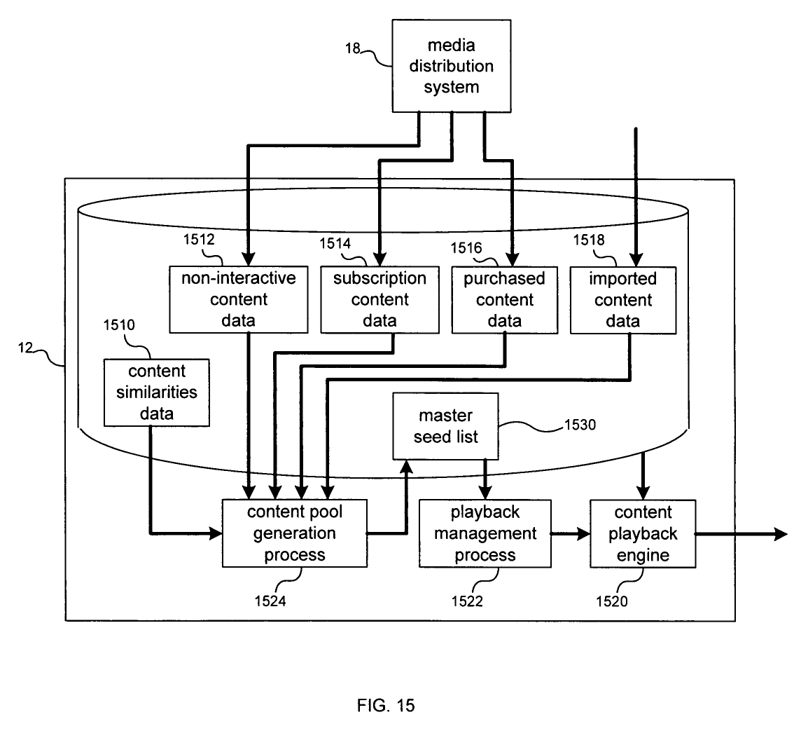

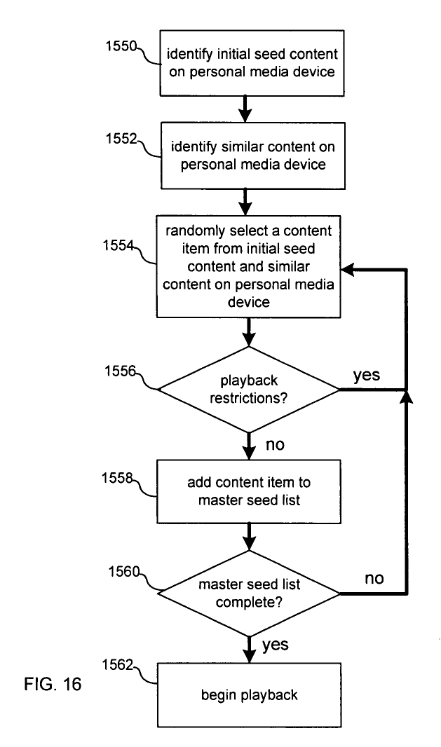

Referring to FIGS. 15-16, there is shown a system and method for local generation of non-interactive media content on a client electronic device (e.g., personal media device 12, client computer 44, or proxy computer 54 shown in FIG. 1). Non-interactive media content (also referred to as radio content) may be generated locally using content on personal media device 12, client computer 44, or proxy computer 54 without having to stream content or provide a content cache from a media distribution system 18.

Non-interactive media content may be used to generate a non-interactive media content playback (also referred to as a radio station) on an electronic device. Media content playback generally refers to the rendering on the electronic device of multiple media content items in a sequence. In an exemplary embodiment, media content items include music tracks, although other types of content items (e.g., videos or movies) may be used in a media content playback.

As used herein, non-interactive means not allowing a user to request a particular content item to be rendered. A non-interactive media content playback may include a plurality of content items selected and arranged randomly or pseudo-randomly for rendering. Non-interactive media content playback may allow some level of user control over playback. For example, a user may start and stop the playback or may skip content items within certain restrictions, as will be described in greater detail below. A user may also suggest the general nature of the content to be included in the content playback. In a non-interactive music content playback or radio station, for example, a user may suggest a musical artist or a genre of music, which may form the basis for randomly or pseudo-randomly selecting content items for playback.

In an exemplary embodiment, non-interactive media content playback may be configured to comply with certain playback requirements, such as the Digital Millennium Copyright Act (“DMCA”). The DMCA includes statutory requirements governing the digital performance of certain sound recordings including, inter alia, the sound recording performance complement restricting the number of times a song, artist, or group of artists may be rendered within a specified time interval. Presently and more specifically, the sound recording performance complement is the transmission, during any three-hour period, of no more than: (A) three different selections of sound recordings from a particular phonorecord (i.e., album), if no more than two such selections are transmitted consecutively; or (B) four different selections of sound recordings by the same recording artist or from any set or compilation of phonorecords (i.e. anthology), if no more than three such selections are transmitted consecutively. Audio and video playback in compliance with performance complement requirements is described for example, in U.S. Pat. No. 6,611,813, which is fully incorporated herein by reference.

Although the exemplary embodiment of non-interactive media content playback may be configured to comply with DMCA requirements, this is not a limitation of the system and method described herein. The Copyright laws, the policies of the American Society of Composers, Authors, and Publishers (ASCAP), and the policies of Broadcast Music, Inc. (BMI) may also define other playback requirements for media content.

The media content stored on personal media device 12 may include non-interactive content data 1512, subscription content data 1514, purchased content data 1516 and imported content data 1518. Non-interactive content data 1512, subscription content data 1514, and purchased content data 1516 may be downloaded from media distribution system 18. Imported content data 1518 may be imported by the user, for example, by ripping a track from a CD. Non-interactive content data 1512 may be in the form of a non-interactive content cache including scrambled media data files. Subscription content data 1514, purchased content data 1516 and imported content data 1518 may be in the form of media data files that may be individually selected and rendered. Subscription content data 1514 may be rendered as long a user subscription remains valid, whereas purchased content data 1516 and imported content data 1518 may be rendered independent of a subscription. Metadata associated with the media content data may also be stored on personal media device 12 and may include identifying information such as track name, artist name, album name, genre, and content item identifiers that uniquely identify content items within a media distribution system 18.

Personal media device 12 may also include content similarities data 1510 including data defining associations between media content that has been determined to be similar. In a music distribution system, for example, content similarities data 1510 may include similar artists (e.g., influences, contemporaries, followers or related projects) for each of the artists associated with the available songs.

Content playback engine 1520 may be resident on and executed by a client electronic device (e.g., personal media device 12, client computer 44, or proxy computer 54 shown in FIG. 1) to perform the core functions or processes associated with rendering media content such as processing media data files. Playback management process 1522 may be resident on and executed by the client electronic device (e.g., personal media device 12, client computer 44, or proxy computer 54 shown in FIG. 1) to manage playback of non-interactive media content, for example, to maintain compliance with DMCA performance complement requirements. Content pool generation process 1524 may be resident on and executed by a client electronic device (e.g., personal media device 12, client computer 44, or proxy computer 54) to generate the content pool and master seed list to be used in a non-interactive media content playback.

Content playback engine 1520, playback management process 1522 and content pool generation process 1524 may be components of device application 64 or client application 46 (see FIG. 1), for example, as an embedded feature, software plug-in, or stand-alone application. The instruction sets and subroutines of content playback engine 1520, playback management process 1522, and content pool generation process 1524 may be executed by one or more processors (not shown) and one or more memory architectures (not shown) (e.g., incorporated into personal media device 12, client computer 44, or proxy computer 54).

An exemplary method for local generation of non-interactive media content is illustrated in FIG. 16 and described below. Personal media device 12 identifies 1550 initial seed content items on personal media device 12. A user may input one or more artist names or genres, for example, and personal media device 12 may retrieve content item identifiers for content items on personal media device 12, which are associated with those artist(s) or genre(s). Content pool generation process 1524, for example, may retrieve the content item identifiers from metadata on personal media device 12. Alternatively, initial seed content items may also be identified automatically. Content pool generation process 1524, for example, may retrieve content item identifiers from user metadata for those content items preferred by a user (e.g., rated high or played frequently). The initial seed content items may be in the form of non-interactive content data 1512 (e.g., a content cache), subscription content data 1514, purchased content data 1516 and/or imported content data 1518 stored on personal media device 12.

Personal media device 12 may then identify 1552 similar content items from the content stored on personal media device 12. Similar content items may include content items from artists in the same genre or content items from artists identified by content similarities data 1510 as being similar (e.g., influences, contemporaries, or followers). Content pool generation process 1524, for example, may access content similarities data 1510 to identify similar artists associated with initial seed content artist(s) and to identify content items by those similar artists. The similar content items may be in the form of non-interactive content data 1512 (e.g., a content cache), subscription content data 1514, purchased content data 1516 and imported content data 1518 stored on personal media device 12.

According to another alternative, personal media device 12 may identify initial seed content items and similar content items as all content items on personal media device 12 that are associated with a particular genre or other characteristic (e.g., a mood or beats per minute). In this alternative embodiment, content pool generation process 1524 may identify initial seed content items and similar content items by accessing metadata on personal media device 12. Thus, content similarities data 1510 may not be necessary.

Personal media device 12 may then establish a master seed list 1530 for the non-interactive media content playback from the initial seed content items and the similar content items on personal media device 12. The master seed list 1530 may include at least the content item identifiers for each of the identified content items. The master seed list 1530 defines a sequence of media content items in compliance with playback requirements such as DMCA performance complement requirements.

To establish master seed list 1530, for example, content pool generation process 1524 may randomly select 1554 one of the identified content items (e.g., initial seed content and similar content items) and may test 1556 the content item to determine if playback restrictions may prevent rendering the selected content item at that point in the sequence. If playback restrictions may prevent rendering the selected content item at that point, content pool generation process 1524 may randomly select 1554 another content item. If playback restrictions would not prevent rendering the selected content item at that point, content pool generation process 1524 may add 1558 the selected content item to the master seed list 1530. The process may be repeated until a master seed list 1530 is completed 1560 with a sufficient number of content items to comply with DMCA or other such requirements. In an exemplary embodiment, a master seed list 1530 may include over 300 musical tracks.

When the master seed list is completed, personal media device 12 may begin playback 1562 of the locally generated non-interactive media content. Alternatively, the locally generated non-interactive media content playback may begin before the master seed list is completed. The locally generated non-interactive media content may be rendered, for example, according to the method illustrated in FIG. 14 and described above. The media content data that is rendered as part of the locally generated non-interactive media content playback, however, may include non-interactive content data 1512, subscription content data 1514, purchased content data 1516, and imported content data 1518.

Accordingly, non-interactive media content (or radio content) may be self-generated locally using media content on a personal media device and may then be played back on personal media device without violating playback requirements such as DMCA performance complement requirements.

Combining Disparate Tracks with Media Content Items Presented as a Non-Interactive Content Playback:

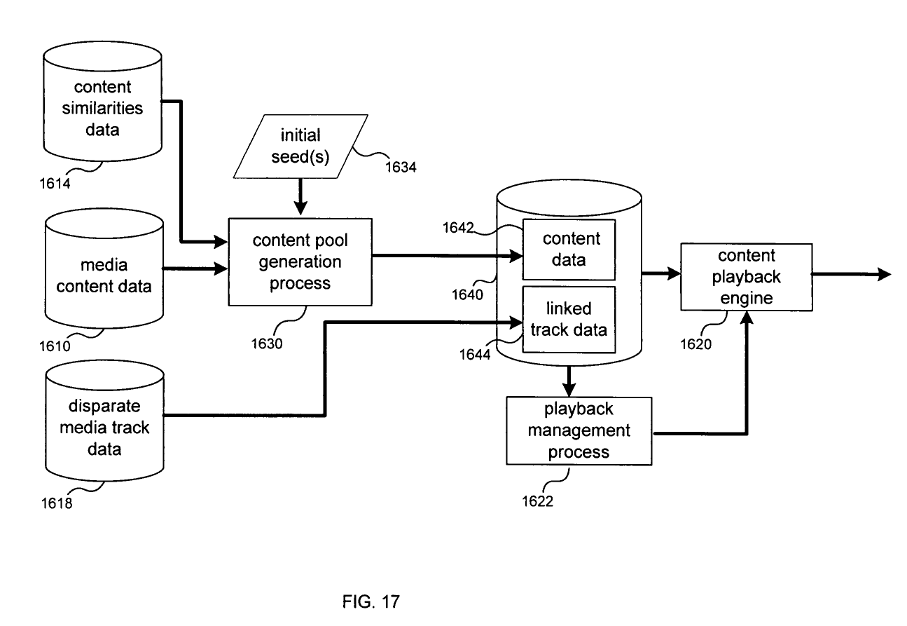

Referring to FIGS. 17-20, there is shown a system and method for combining disparate media tracks with non-interactive media content (also referred to as radio content). A user may generate disparate media tracks, for example, by recording a commentary or introduction for a media content item such as a music track. Non-interactive media content and disparate media tracks may be used to generate a non-interactive media content playback (also referred to as a radio station) on an electronic device. A user may thus generate a personalized radio station including the commentary or introduction tracks.

Media content playback generally refers to the rendering on the electronic device of multiple media content items in a sequence. In an exemplary embodiment, media content items include music tracks, although other types of content items (e.g., videos or movies) may be used in a media content playback. As used herein, non-interactive means not allowing a user to request a particular content item to be rendered. A non-interactive media content playback may include a plurality of content items selected and arranged randomly or pseudo-randomly for rendering. Non-interactive media content playback may allow some level of user control over playback. For example, a user may start and stop the playback or may skip content items within certain restrictions, as will be described in greater detail below. A user may also suggest the general nature of the content to be included in the content playback. In a non-interactive music content playback or radio station, for example, a user may suggest a musical artist or a genre of music, which may form the basis for randomly or pseudo-randomly selecting content items for playback.

In an exemplary embodiment, non-interactive media content playback may be configured to comply with certain playback requirements, such as the Digital Millennium Copyright Act (“DMCA”). The DMCA includes statutory requirements governing the digital performance of certain sound recordings including, inter alia, the sound recording performance complement restricting the number of times a song, artist, or group of artists may be rendered within a specified time interval. Presently and more specifically, the sound recording performance complement is the transmission, during any three-hour period, of no more than: (A) three different selections of sound recordings from a particular phonorecord (i.e., album), if no more than two such selections are transmitted consecutively; or (B) four different selections of sound recordings by the same recording artist or from any set or compilation of phonorecords (i.e. anthology), if no more than three such selections are transmitted consecutively. Audio and video playback in compliance with performance complement requirements is described for example, in U.S. Pat. No. 6,611,813, which is fully incorporated herein by reference.

Although the exemplary embodiment of non-interactive media content playback may be configured to comply with DMCA requirements, this is not a limitation of the system and method described herein. The Copyright laws, the policies of the American Society of Composers, Authors, and Publishers (ASCAP), and the policies of Broadcast Music, Inc. (BMI) may also define other playback requirements for media content.

The system and method of combining disparate tracks with media content items may be implemented on a client electronic device (e.g., personal media device 12, client computer 44, proxy computer 54 shown in FIG. 1) and/or on a server device (e.g., computer 28 shown in FIG. 1). Media content data 1610 and disparate media track data 1618 may be stored, for example, on server computer 28. Media content data 1610 may include audio data files (e.g., music), video data files, audio/video data files, and multimedia data files. Media content data 1410 generally provides the media content for generating non-interactive media content.

Disparate media track data 1620 may include audio data files, video data files, audio/video data files and multimedia data files for tracks that are recorded separately from media content items and are generally not part of the media content. Disparate media tracks may include personalized audio commentary tracks, for example, recorded by a user for introducing selected media content items. Disparate media tracks may also include advertisements or public service announcements. One or more disparate media tracks may be linked to one or more media content items. For example, each of the disparate media track data files may include content item identifier(s) (e.g., in the header of the file) associated with linked content items.

Content similarities data 1614 may also be stored on server computer 28 and may include data defining associations between media content that has been determined to be similar. In a music distribution system, for example, content similarities data 1614 may define similar artists (e.g., artists who are influences, contemporaries, followers or involved in related projects) for each of the artists associated with the available songs.

Non-interactive content 1640 may be stored on a client electronic device (e.g., on personal media device 12, client computer 44, or proxy computer 54) with a master seed list defining an initial sequence in which content items are to be rendered, as described above. Non-interactive content 1640 may include content data 1642 for content items (e.g., music tracks) and linked track data 1644 for disparate tracks linked to the content items (e.g., commentary or intro tracks). Personal media device 12 may store non-interactive content 1640, for example, as a content cache constructed from media content data 1610 and including one or more media data files in a scrambled file format. Alternatively, non-interactive media content 1640 may be streamed from media distribution system 18 to a client electronic device (e.g., personal media device 12, client computer 44, or proxy computer 54) in multiple pieces that may be buffered and rendered by the client electronic device.

Content playback engine 1620 may be resident on and executed by a client electronic device (e.g., personal media device 12, client computer 44, or proxy computer 54 shown in FIG. 1) to perform the core functions or processes associated with rendering media content such as processing media data files. Playback management process 1622 may be resident on and executed by either a client electronic device (e.g., personal media device 12, client computer 44, or proxy computer 54 shown in FIG. 1) or a server device (e.g., server computer 28 shown in FIG. 1) to manage playback of non-interactive media content, for example, to maintain compliance with DMCA performance complement requirements. Content pool generation process 1630 may be resident on and executed by server computer 28 to generate the content pool and master seed list to be used in a non-interactive media content playback.

Content playback engine 1620 and playback management process 1622 may be components of device application 64 or client application 46 (see FIG. 1), for example, as an embedded feature, software plug-in, or stand-alone application. Content pool generation process 1630 may be a component of media distribution system 18, for example, as an embedded feature, software plug-in, or stand-alone application. The instruction sets and subroutines of content playback engine 1620, playback management process 1622, and content pool generation process 1630 may be executed by one or more processors (not shown) and one or more memory architectures (not shown) (e.g., incorporated into personal media device 12, client computer 44, proxy computer 54, and/or server computer 28).

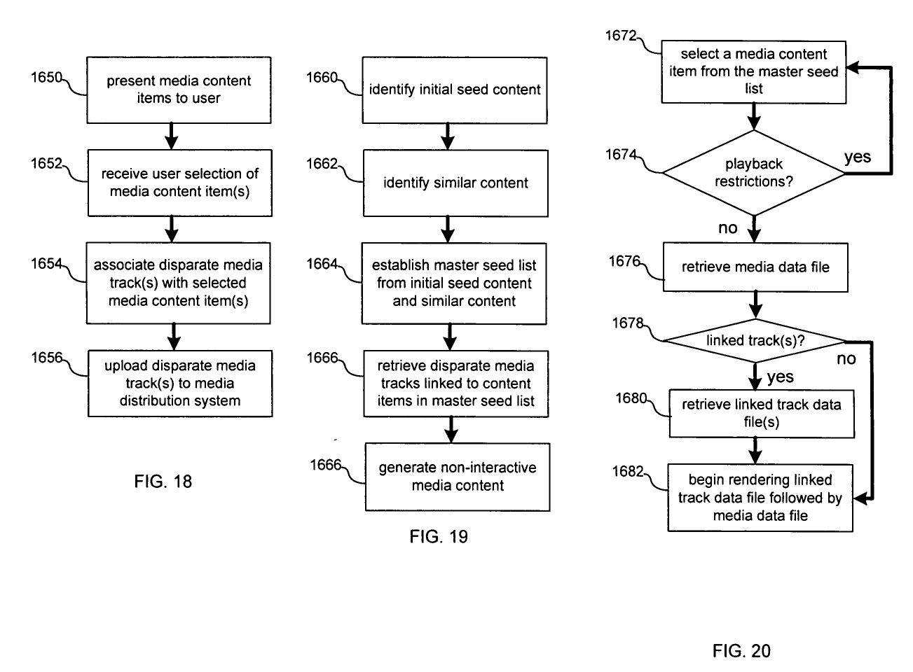

One exemplary method of generating disparate media tracks linked to media content items is illustrated in FIG. 18. A client electronic device (e.g., personal media device 12, client computer 44, or proxy computer 54) may present 1650 media content items (e.g., music tracks) to a user, for example, by displaying identifying information (e.g., track name, artist name, album name) associated with the media content items. The electronic device may then receive 1642 a user selection of one or more of the content items presented. Upon receiving a user selection, the electronic device may associate 1654 one or more disparate media tracks with the selected content item(s). The electronic device may be used to digitally record the disparate media track or to retrieve a pre-recorded disparate media track. To associate the disparate media track, the client electronic device may add a content item identifier associated with each selected content item to metadata for the disparate media track. The user may associate a disparate media track with an entire album (e.g., by adding content item identifiers for all content items on the album) or with an artist (e.g., by adding content item identifiers for all content items for that artist). The disparate media track with the associated media content item identifier(s) may be uploaded 1656 to a media distribution system.

This method may be performed as part of a method of generating a non-interactive media content playback (e.g., a radio station). The user may provide the media content items with the linked disparate media tracks to media distribution system 18 for use as initial seed content in generating a content seed pool, as described below.

One exemplary method of combining disparate media tracks with media content to generate non-interactive media content is illustrated in FIG. 19. A content generating device (e.g., server computer 28 shown in FIG. 1) may identify 1660 initial seed content. Content pool generation process 1630, for example, may receive an input of one or more artist names or genres and may retrieve (e.g., from metadata) content item identifiers associated with those artist(s) or genre(s).

The content generating device may then identify 1662 similar seed content from the initial seed content, for example, using content similarities data 1614. When given an artist name, for example, content pool generation process 1630 may retrieve similar artists (e.g., influences, contemporaries, followers, or related projects) from content similarities data 1614. Content pool generation process 1630 may then establish 1664 a master seed list from the initial seed content and the similar content (e.g., the content by the similar artists). Content pool generation process 1630 may also retrieve 1666 disparate media tracks linked to the content items in the master seed pool and generates 1668 non-interactive media content 1640 from the media data files and disparate media track data files for the content items in the master seed list. Content generating device may then send non-interactive media content 1640 to a rendering device (e.g., personal media device 12), for example, as a content cache or as a stream.

An exemplary method of rendering a non-interactive media content playback with linked disparate media tracks is illustrated in FIG. 20 and described below. Upon starting playback, a rendering device (or media distribution system 18 if streaming) may select 1672 a media content item from a master seed list, for example, as described above.

After selecting a media content item, the rendering device (or alternatively the media distribution system if streaming) may determine 1674 if any playback restrictions (e.g., performance complement restrictions) would prevent the selected content item from being rendered at that point in the sequence. Playback management process 1622, for example, may track data for all non-interactive media content that is rendered (e.g., the artist name and the album name) and may check or test each content item against the tracked data. One example of such performance complement testing is described in greater detail in U.S. Pat. No. 6,611,813, which is fully incorporated herein by reference. If non-interactive media content 1640 is provided to personal media device 12 as a content cache, playback management process 1622 may be executed by personal media device 12. If non-interactive media content 1640 is streamed to the rendering device (e.g., personal media device 12) from media distribution system 18, playback management process 1622 may be executed by media distribution system 18.

If playback restrictions prevent the content item from being rendered, another media content item (e.g., the next item in the content seed list) may be selected 1672 and tested 1674 for compliance. If playback restrictions do not prevent the content item from being rendered, the rendering device may retrieve 1676 the content item. Content playback engine 1620, for example, may use the content identifier from the master seed list to locate and retrieve the corresponding media data file from content data 1642. Content playback engine 1620 may also determine 1678 if any disparate media tracks are linked to the media data file, for example, by searching linked track data 1644 for linked track data files with a content item identifier matching the selected media content item. If linked tracks are located, content playback engine 1620 may retrieve 1680 the disparate media track data files from linked track data 1644. If multiple disparate media tracks are linked to a selected media content item, one of the disparate media tracks may be randomly selected for rendering with the media content data file.

Content playback engine 1620 may then begin rendering 1682 a linked disparate media track data file followed by the media data file retrieved for the content item. The non-interactive media content playback may continue until content playback engine 1620 determines that rendering is completed, the content item is skipped, or playback is stopped, as described above.

Alternatively, if non-interactive media content 1640 is streamed to the rendering device from media distribution system 18, media distribution system 18 may retrieve the media content data files from media content data 1610 and any linked disparate media data files from disparate media track data 1618. Content playback engine 1620 may receive and render pieces of the linked disparate media data file(s) and media content data file as they are streamed.

Accordingly, a system and method of combining disparate tracks with media content items presented as non-interactive content playback allows a user to generate personalized radio stations with commentary or introduction tracks preceding music tracks.

A number of implementations have been described. Nevertheless, it will be understood that various modifications may be made. Accordingly, other implementations are within the scope of the following claims.

What is claimed is:

1. A method comprising:
receiving a selected color representation selected by a user;
retrieving at least one characteristic associated with the selected color representation;
identifying one or more media data files, chosen from a plurality of media data files, associated with the at least one characteristic; and
presenting the one or more media data files associated with the at least one characteristic to the user.

2. The method of claim 1 wherein the at least one characteristic retrieved includes one or more of a mood indicator and a beats-per minute (BPM) indicator.

3. The method of claim 1 further comprising:
presenting a plurality of color representations to the user;
wherein one or more characteristics are associated with each of the plurality of color representations; and
wherein the selected color representation is chosen by the user from the plurality of color representations.

4. The method of claim 1 wherein the plurality of media data files are located on a personal media device.

5. The method of claim 4 further comprising:
rendering, on the personal media device, the one or more media data files associated with the at least one characteristic.

6. The method of claim 1 further comprising:
defining metadata for a media data file, chosen from the plurality of media data files, wherein the metadata defines a characteristic of the media data file.

7. A computer program product residing on a computer readable medium having a plurality of instructions stored thereon that, when executed by a processor, cause the processor to perform operations comprising:
receiving a selected color representation selected by a user;
retrieving at least one characteristic associated with the selected color representation;
identifying one or more media data files, chosen from a plurality of media data files, associated with the at least one characteristic; and
presenting the one or more media data files associated with the at least one characteristic to the user.

8. The computer program product of claim 7 wherein the at least one characteristic retrieved includes one or more of a mood indicator and a beats-per minute (BPM) indicator.

9. The computer program product of claim 7 further comprising instructions for performing operations comprising:
presenting a plurality of color representations to the user;
wherein one or more characteristics are associated with each of the plurality of color representations; and
wherein the selected color representation is chosen by the user from the plurality of color representations.

10. The computer program product of claim 7 wherein the plurality of media data files are located on a personal media device.

11. The computer program product of claim 10 further comprising instructions for performing operations comprising:
rendering, on the personal media device, the one or more media data files associated with the at least one characteristic.

12. The computer program product of claim 7 further comprising instructions for performing operations comprising:
defining metadata for a media data file, chosen from the plurality of media data files, wherein the metadata defines a characteristic of the media data file.

13. A computing device configured to perform operations comprising:
receiving a selected color representation selected by a user;
retrieving at least one characteristic associated with the selected color representation;
identifying one or more media data files, chosen from a plurality of media data files, associated with the at least one characteristic; and
presenting the one or more media data files associated with the at least one characteristic to the user.

14. The computing device of claim 13 wherein the at least one characteristic retrieved includes one or more of a mood indicator and a beats-per minute (BPM) indicator.

15. The computing device of claim 13, wherein the computing device is further configured to perform operations comprising:
presenting a plurality of color representations to the user;
wherein one or more characteristics are associated with each of the plurality of color representations; and
wherein the selected color representation is chosen by the user from the plurality of color representations.

16. The computing device of claim 13 wherein the plurality of media data files are located on the computing device.

17. The computing device of claim 16, wherein the computing device is further configured to perform operations comprising:
rendering the one or more media data files associated with the at least one characteristic.

18. The computing device of claim 13 wherein the computing device is further configured to perform operations comprising:
defining metadata for a media data file, chosen from the plurality of media data files, wherein the metadata defines a characteristic of the media data file.

19. The computing device of claim 13 wherein the computing device is chosen from the group consisting of a personal media device, a client computer, a personal digital assistant, a cellular telephone, a television, a cable box, an internet radio, and a dedicated network device.
